(19) United States
(12) Patent Application Publication
(10) Pub. No.: US 2009/0223640 A1
(43) Pub. Date: Sep. 10, 2009

(54) HANGER ASSEMBLY FOR DISPLAYING THE LOUVERS OF VERTICAL WINDOW BLINDS

(75) Inventor: Tung-Jung Chen, Taichung (TW)

Correspondence Address: PAI PATENT & TRADEMARK LAW FIRM, 1001 FOURTH AVENUE, SUITE 3200, SEATTLE, WA, 98154, US

(73) Assignee: NIEN MADE ENTERPRISE CO., LTD., Taichung (TW)

(21) Appl. No.: 12/043,117

(22) Filed: Mar. 5, 2008

(51) Int. Cl. E06B 9/36

(52) U.S. Cl. 160/178.1 V; 248/339

(57) ABSTRACT

A hanger assembly for displaying the louvers of vertical window blinds, being used to hang a group of louvers comprising a plurality of overlapping louvers. A hanging hole is formed passing through an end towards a major axis of the group of louvers. The hanger assembly comprises a hanging member and a connection member passing through the hanging hole of the group of louvers, in which one end is formed at a predetermined position of the hanging member and the other end is provided with at least a stopper corresponding to an extreme outside of the group of louvers to make the group of louvers axially wiggle along a predetermined portion of the connection member and to further house the hanging member in the group of louvers, preventing the hanging member from being damaged during shipment or carry and reducing a material of package and cost of stock and shipment.

### BACKGROUND OF THE INVENTION

1. Field of the Invention

This invention relates to an assembly used for the louvers of vertical window blinds and particularly to a hanger assembly used for displaying the louvers of vertical window blinds in a selling exhibition where a consumer chooses for different styles.

2. Description of Related Art

In order to allow a consumer to easily choose the louvers of window blind with different materials or in different colors, a business owner generally overlaps vertical louvers with the same size, shape, color and design, and arranges them into a group of louvers and uses a suspender to hang it on a display rack for the consumer to choose.

In order to make better hanging of the louvers of vertical window blinds effective for display, a hanger assembly for displaying the louvers of vertical window blinds is disclosed in U.S. Pat. Nos. 6,446,932 and 6,164,617, in which the hanger unit comprises a hanging assembly, in which a pin assembly and a suspension portion is provided at a top end of the hanging assembly and a fixing portion is provided extending from a bottom end of the hanging assembly; a opening is formed passing through the suspension portion and two protuberances or a support plate is provided in parallel on the fixing portion around under the opening and exactly against a top end of the vertical louvers, and a locating hole is formed at a bottom end of the two protuberances or support plate; the pin is made of an elastic rubber into a head and body extending from a bottom end of the head, in which an external diameter of the head is larger than an aperture of the hanging hole of the group of louvers and several fixing parts protruding equidistantly on the body of pin. The pin passes through the hanging hole of the louvers so that the head of pin is definitely located outside one side of the vertical louvers, and the end of pin passes through the locating hole of hanging assembly so that the hanging assembly is definitely located outside the other side of the group of louvers. With the protuberances (or the support plate) and the elastic part that work with each other, the vertical louvers may be securely hanged on the hanger unit.

Although the conventional hanger assembly may easily hang the vertical louvers and definitely locate the vertical louvers, at the time of shipment, the hanging assembly protruding out of the groups of louvers occupies more space and increases the cost of stock and shipment and when being shipped or carried, the groups of louvers crowd and collide with each other, causing the hanging assembly to be damaged.

Consequently, because of the technical defects of described above, the applicant keeps on carving unflaggingly through wholehearted experience and research to develop the present invention, which can effectively improve the defects described above.

### SUMMARY OF THE INVENTION

In this invention, a hanger assembly for displaying the louvers of vertical window blinds is provided. The group of louvers comprises a plurality of overlapping louvers, and a hanging hole is formed passing through an end towards a major axis of the group of louvers. The hanger assembly comprises a hanging member and a connection member, in which the connection member is provided passing through the hanging hole of the group of louvers, in which one end is formed at a predetermined position of the hanging member and the other end is provided with at least a stopper that is corresponding to an extreme outside of the group of louvers to locate the group of louvers in the hanging hole of hanging member to axially wiggle.

According to this invention of the hanger assembly for displaying the vertical louvers, the group of louvers is pivoted onto the connection member with the combination of the connection member and hanging hole. At the time of shipment, the hanging member may be housed in the group of louvers so that the group of louvers may be neatly placed in a box, preventing the hanging member from being damaged by collision during shipment, and the louvers may be easily hanged on a shelf for display by the hanging member.

### BRIEF DESCRIPTION OF THE DRAWINGS

FIG. 1 is a view of the appearance of an assembly in a first preferred embodiment of this invention;

FIG. 2 is an exploded view of the first preferred embodiment of this invention;

FIG. 3 is a sectional view of the assembly in the first preferred embodiment of this invention;

FIG. 4 is a schematic view illustrating the service of assembly in the first preferred embodiment of this invention;

FIG. 5 is a schematic view illustrating the assembly hanged on a rack in the first preferred embodiment of this invention;

FIG. 6 is a sectional view of the assembly in a second preferred embodiment of this invention;

FIG. 7 is an exploded view of a third preferred embodiment of this invention;

FIG. 8 is a view of the appearance of the assembly in the third preferred embodiment of this invention;

FIG. 9 is a view of the appearance of assembly in a fourth preferred embodiment of this invention;

FIG. 10 is a sectional view of the assembly in the fourth preferred embodiment of this invention; and

FIG. 11 is a sectional view of the assembly in the fourth preferred embodiment of this invention after a hot stamping is applied.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

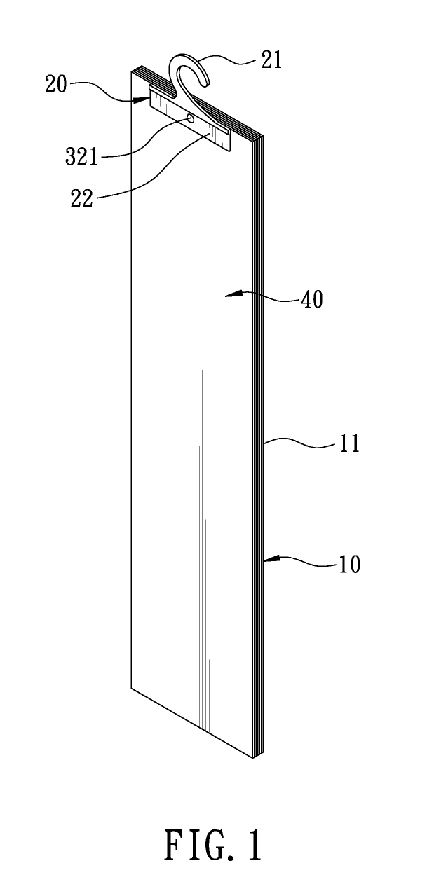

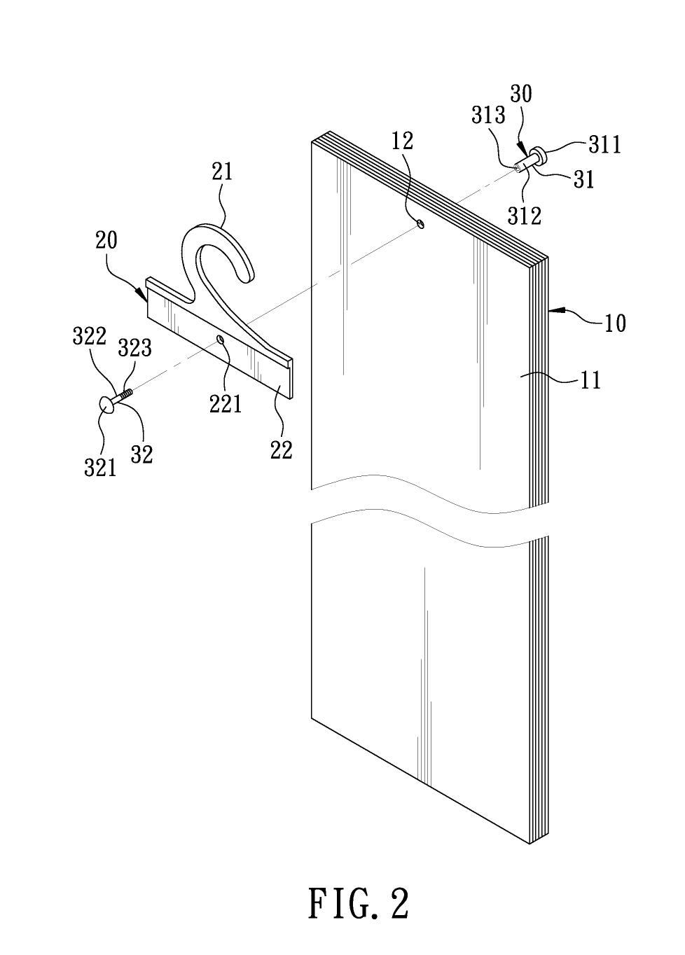

Refer to FIGS. 1 and 2 as respectively a semblance view and an exploded view of a hanger assembly working with a group of louvers 10 in a first preferred embodiment.

The group of louvers 10 comprises a plurality of overlapping louvers 11, and a hanging hole 12 is formed passing through an end towards a major axis of the group of louvers 10.

The hanger assembly mainly comprises a hanging member 20, a connection member 30, and a contractive membrane 40.

The hanging member 20 mainly comprises a suspension portion 21, from which a connection portion 22 integrally extends downwards. In the embodiment, the suspension portion 21 is in a form of hook. The connection portion 22 is a rectangular slab through which a round connection hole 221 is formed passing.

The connection member 30 is pivoted onto the connection hole 221, comprising a first fastener 31 and a second fastener 32 that are made of adequately rigid metal or plastics, in which the second fastener 32 may be a rivet or a screw. In the embodiment, the screw is taken for example; the first and second fasteners 31 and 32 are respectively provided with first and second heads 311 and 321 and first and second bodies 312 and 322; the first and second heads 311 and 321 in external diameter are respectively larger than hanging hole 12 of the group of louvers 10 in aperture and the first and second bodies 312 and 322 on external diameter, in which a tapped hole 313 is formed at a bottom end of the first body 312 and an external thread 323 is formed on the second body 322.

The contractive membrane 40 wraps around a surface of the group of louvers 10, and the first and second heads 311 and 321 and the connection portion 22 are respectively outside two ends of the membrane 40.

In order to further make apparent the structural features, applied skill and manners, and expected effects according to this invention, what are applied in this invention are in detail described, and it is thus believed that this invention is thoroughly and concretely apparent, as described below.

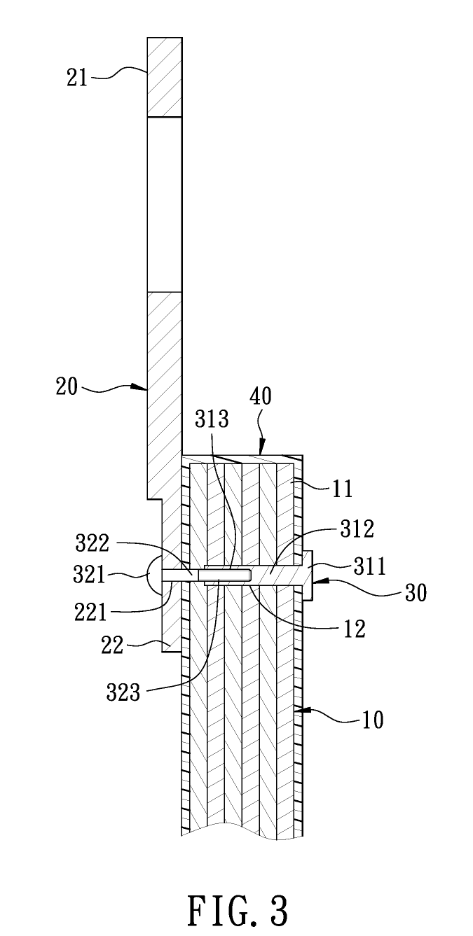

As shown in FIG. 3, when assembled, the first body 312 and the second body 322 pass through the hanging hole 12 of the group of louvers 10 from a rear portion of the group of louvers 10 and a front side of the hanging member 20 respectively to screw each other. The first head 311 and the connection portion 22 are respectively located outside the contractive membrane 40 so as to position the group of louvers 10 between the hanging member 20 and the first head 311 of first fastener 31 and make it wiggle along an axis of the connection member 30.

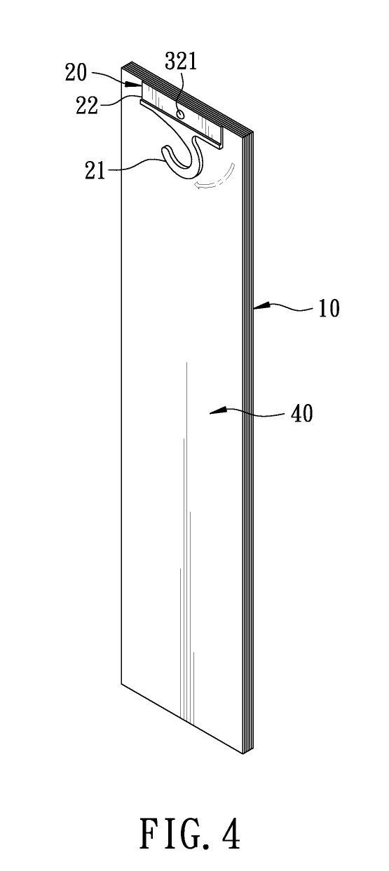

As shown in FIG. 4, for storage, a user may rotate the hanging member 20 and keep the suspension portion 21 close to the front side of the group of louvers 10, causing the suspension portion 21 not to protrude out of the group of louvers 10 for reduction of more occupied space and prevention of damage due to collision. Further, the contractive membrane 40 is used to wrap around the surface of group of louvers 10 to prevent the surface of vertical louvers 11 from being damaged during shipment.

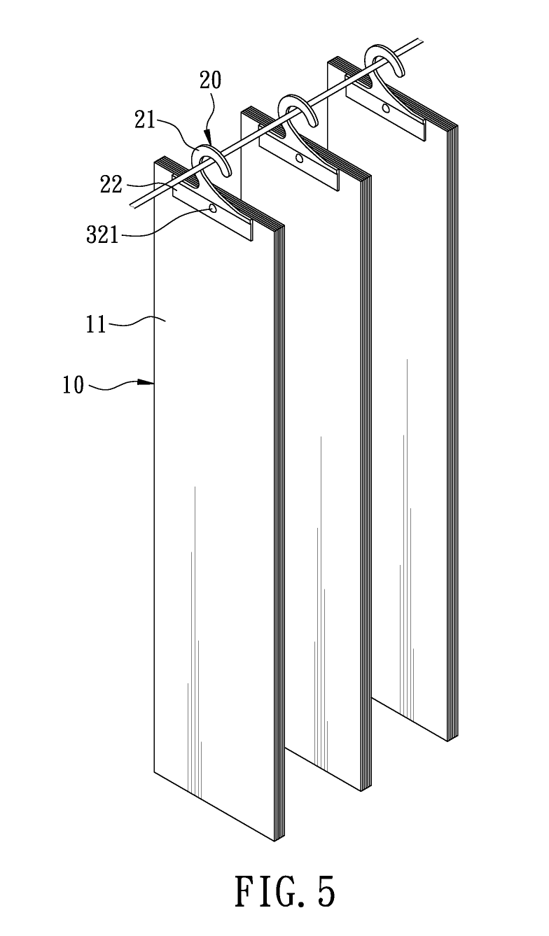

With reference to FIG. 5, for use, the user may rotate the hanging member 20 to make the suspension portion 21 extend out of the group of louvers 10, thereby being convenient for the group of louvers 10 to be hanged on a rod-like display shelf. Further, the contractive membrane 40 is used to wrap around the surface of group of louvers 10 to prevent the surface of vertical louvers 11 from being damaged during display.

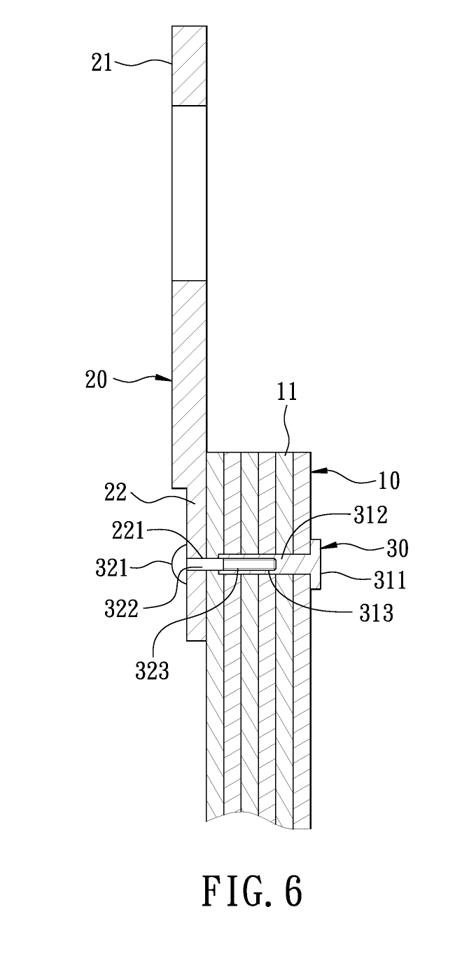

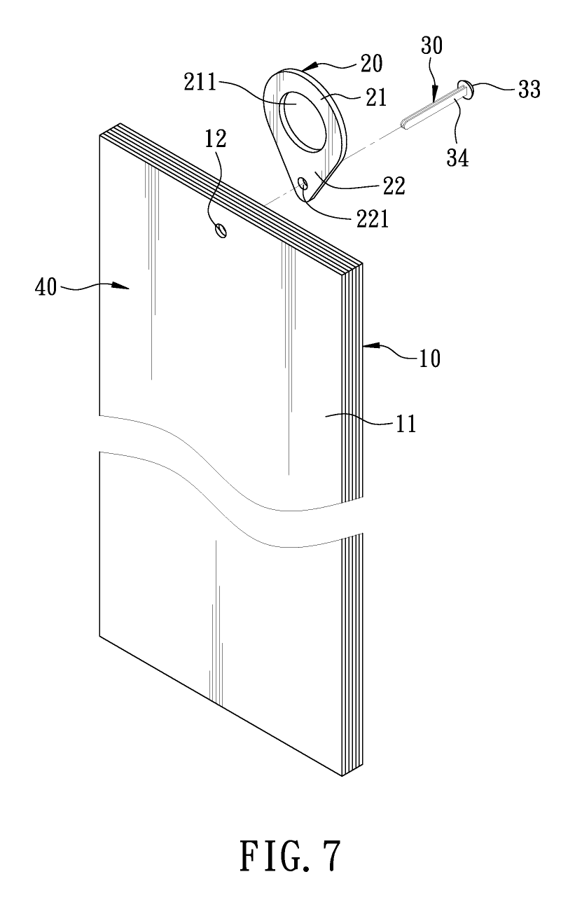

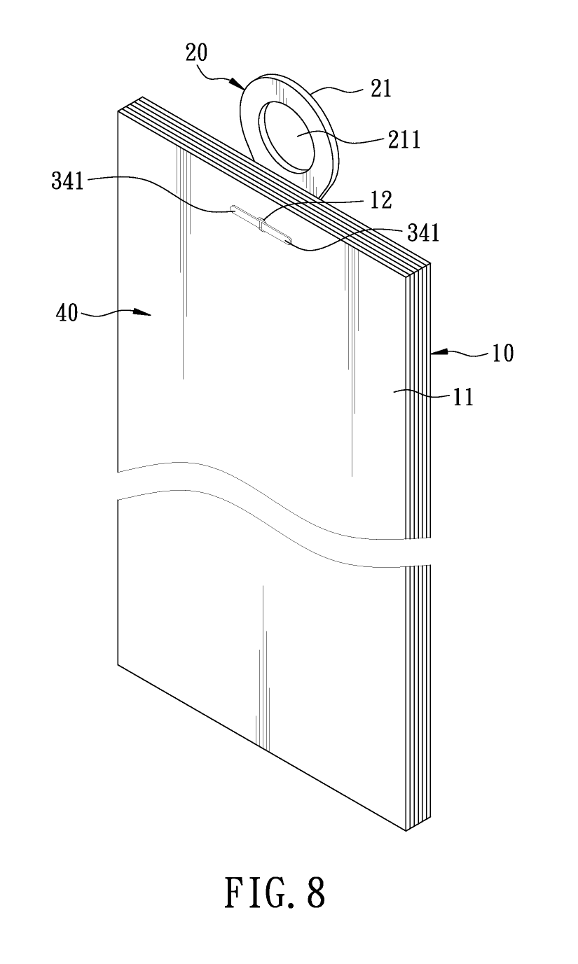

With reference to FIG. 6 as a sectional view of the assembly of a second embodiment of this invention, the structure and function of the hanger assembly that is disclosed in this invention is the same as that in the first embodiment of this invention, and what is slightly different is in that no contractive membrane 40 wraps around the surface of the group of louvers 10. With reference to FIGS. 7 and 8 respectively as a exploded view and a assembly view of a third embodiment of this invention, the hanging member 20 is a slab in a water-drop form, in which the suspension portion 21 is a round slab, a circular aperture 211 is formed passing through the center of suspension portion 21, and the connection hole 221 is formed on the connection portion 22.

The major structure and function of the hanger assembly disclosed in this invention is approximately the same as that in the first preferred embodiment of this invention, and what is slightly different is in that the connection member 30 is an organic-whole single member provided with a head 33 and at last a leg pillar 34 that extends axially from the bottom of head 33 adequately and is pivoted onto the connection portion 22.

At the time of assembly, the leg pillar 34 is made to pass from the rear of connection portion 22 through the connection hole 221, the contractive membrane 40, and the hanging hole 12, sequentially. The leg pillar 34 protrudes outside the front of the group of louvers 10 and is provided with a transformed section (not shown) that may be bent to form a stopper 341 definitely locating the group of louvers 10 between the hanging member 20 and the stopper 341.

Practically, the leg pillar 34 may be in the form of hollow plastic column, of which the stopper 341 may be formed and enlarged after being applied with a hot stamping. The round leg pillar 34 may be still provided with a smooth surface so that the group of louvers 10 may axially wiggle along the leg pillar 34.

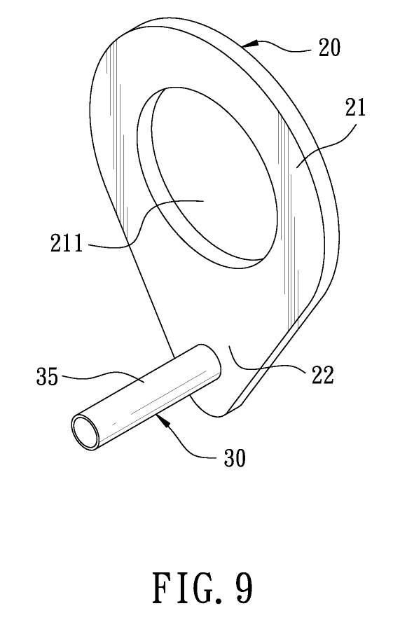

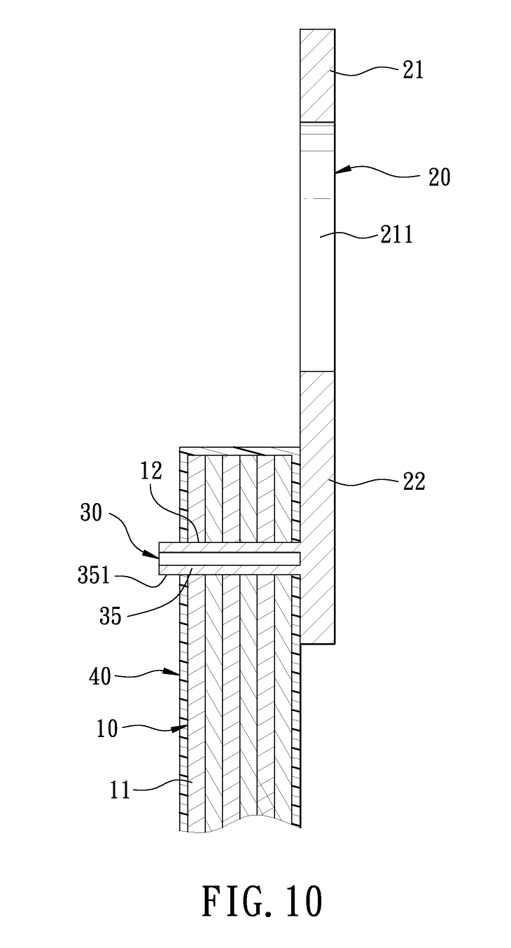

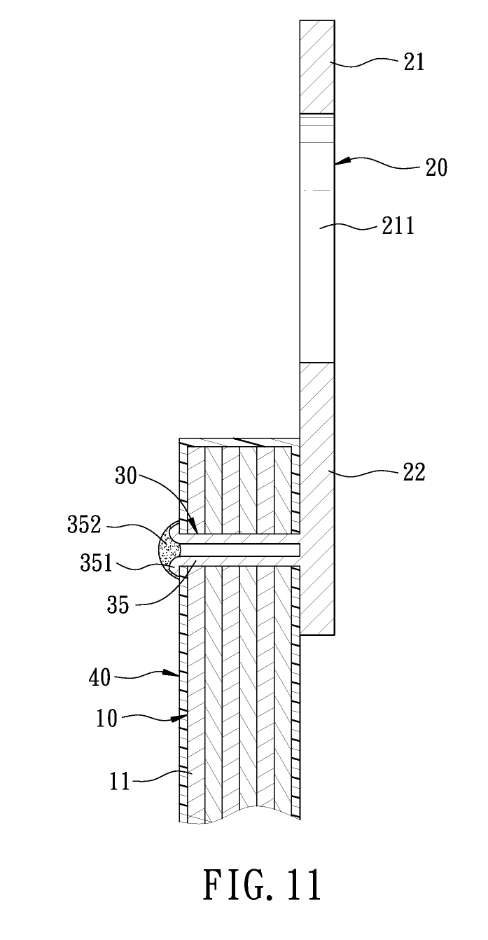

With reference to FIGS. 9 through 11 respectively as a semblance view and an assembly sectional view of a fourth embodiment of this invention, the structure and function of the hanger assembly is approximately the same as that in the preferred embodiment of this invention, and what is different is in that the connection member 30 is integrally formed on the connection portion 22 of the hanging member 20. The connection member 30 is provided with a round hollow leg pillar 35, being made of adequately rigid plastics. The contractive membrane 40 wraps around the surface of group of louvers 10.

At the time of assembly, the leg pillar 35 is made to pass through the contractive membrane 40 and the hanging hole 12, and a transformed portion 351 of the pillar 35 that protrudes outside the group of louvers 10 is formed. The transformed 351, after being applied with the hot stamping and thus enlarged, is formed with a stopper 352 that protrudes outside the contractive membrane 40 corresponding to the surface of vertical louvers 11 extremely outside the group of louvers 10 and the group of louvers 10 may axially wiggle along the leg pillar 35. In the embodiment, the leg pillar of the connection member 30 may also be made of an adequately rigid metal, of which the transformed portion 351 that protrudes out of the group of louvers 10 may be further bent to form the stopper 352.

Here, the features and attainable expected effects of this invention are described again below.

In this invention, the connection member is provided at one side of the hanging member, of which a predetermined portion passes through the hanging hole; the smooth surface of the connection member is used to make the group of louvers axially wiggle along the predetermined portion of the connection member, and the hanging member may be further housed in the group of louvers so that the group of louvers may be orderly placed in the box for easy packing and shipment; the contractive membrane is used to wrap around the surface of group of louvers, preventing the surface of group of louvers from being scratched.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A hanger assembly for displaying the louvers of vertical window blinds, being used to hang a group of louvers comprising a plurality of overlapping louvers, a hanging hole being formed that passes through an end towards a major axis of the group of louvers, the hanger assembly comprising:
a hanging member provided with a suspension portion from which a connection portion extends downwards;
a connection member being pivoted onto the connection portion and comprising two fasteners separately provided with a head and a body, in which the heads in external diameter is larger than the hanging hole of the group of louvers in aperture, and the bodies assemble with each other from two separate extreme outsides of the group of louvers and thus pass through the hanging hole, thereby making the group of louvers locate between the hanging member and the head not adjacent to the hanging member.

2. The hanger assembly for displaying the louvers of vertical window blinds according to claim 1, wherein it further comprises a contractive membrane wrapping around the surface of group of louvers and the connection portion and each of the heads are located outside the contractive membrane.

3. The hanger assembly for displaying the louvers of vertical window blinds according to claim 1, wherein the connection member is made of an adequately rigid metal or plastics.

4. The hanger assembly for displaying the louvers of vertical window blinds according to claim 1, wherein one of the fastener is a rivet or a screw.

5. A hanger assembly for displaying the louvers of vertical window blinds, being used to hang a group of louvers comprising a plurality of overlapping louvers, a hanging hole being formed that passes through an end towards a major axis of the group of louvers, the hanger assembly comprising:
a hanging member provided with a suspension portion from which a connection portion extends downwards; and
a connection member is adequately rigid, of which one end is connected to a predetermined position of the connection portion and the other end extends from the connection portion to form at least a leg pillar passing through the hanging hole of the group of louvers and being provided with a transformed portion that protrudes extremely outside the group of louvers, in which the transformed portion is bent and enlarged, after being applied with a hot stamping, so as to form a stopper that is corresponding to an extreme outside of the group of louvers, thereby making the group of louvers locate between the hanging member and the stopper.

6. The hanger assembly for displaying the louvers of vertical window blinds according to claim 5, wherein the connection member is integrally formed at the predetermined portion of the connection portion.

7. The hanger assembly for displaying the louvers of vertical window blinds according to claim 5, wherein it further comprises a contractive membrane wrapping around the surface of group of louvers and being located between the hanging member and the stopper.

8. The hanger assembly for displaying the louvers of vertical window blinds according to claim 6, wherein it further comprises a contractive membrane wrapping around the surface of group of louvers and being located between the hanging member and the stopper.

9. A hanger assembly for displaying the louvers of vertical window blinds, being used to hang a group of louvers comprising a plurality of overlapping louvers, a hanging hole being formed that passes through an end towards a major axis of the group of louvers, the hanger assembly comprising:
a hanging member provided with a suspension portion from which a connection portion extends downwards; and
a connection member passing through the hanging hole of group of louvers, of which one end is formed at a predetermined position of the connection portion and the other end is provided with at least one stopper corresponding to at an extreme outside of the group of louvers; and
a contractive membrane wrapping around the surface of group of louvers and the connection portion and the stopper are located outside the contractive membrane.

10. The hanger assembly for displaying the louvers of vertical window blinds according to claim 9, wherein the connection member comprises two fasteners assembling with each other from two separate extreme outsides of the group of louvers and thus passing through the hanging hole of the group of louvers.

11. The hanger assembly for displaying the louvers of vertical window blinds according to claim 9, wherein the connection member is provided with a head pivoted onto the connection portion and at least one leg pillar is formed axially extending from the bottom of head.

12. The hanger assembly for displaying the louvers of vertical window blinds according to claim 11, wherein the connection member is made of an adequately rigid metal and the stopper is formed with a transformed portion of the leg pillar that is bent protruding out of the group of louvers.

13. The hanger assembly for displaying the louvers of vertical window blinds according to claim 11, wherein the connection member is made of plastics and the stopper is formed with a transformed portion of the leg pillar that is thermally pressured and enlarged protruding out of the group of louvers.

14. The hanger assembly for displaying the louvers of vertical window blinds according to claim 9, wherein the connection member is integrally formed at the predetermined portion of the connection portion.

15. The hanger assembly for displaying the louvers of vertical window blinds according to claim 14, wherein the connection member is made of an adequately rigid metal and the stopper is formed with a transformed portion of the leg pillar that is bent protruding out of the group of louvers.

16. The hanger assembly for displaying the louvers of vertical window blinds according to claim 14, wherein the connection member is made of plastics and the stopper is formed with a transformed portion of the leg pillar that is thermally pressured and enlarged protruding out of the group of louvers.

17. The hanger assembly for displaying the louvers of vertical window blinds according to claim 9, wherein the connection member is made of an adequately rigid metal and the stopper is formed with a transformed portion of the leg pillar that is bent protruding out of the group of louvers.

18. The hanger assembly for displaying the louvers of vertical window blinds according to claim 9, wherein the connection member is made of plastics and the stopper is formed with a transformed portion of the leg pillar that is thermally pressured and enlarged protruding out of the group of louvers.
